(19) United States
(12) Patent Application Publication
(10) Pub. No.: US 2018/0197548 A1
(43) Pub. Date: Jul. 12, 2018

(54) SYSTEM AND METHOD FOR DIARIZATION OF SPEECH, AUTOMATED GENERATION OF TRANSCRIPTS, AND AUTOMATIC INFORMATION EXTRACTION

(71) Applicant: Onu Technology Inc., San Jose, CA (US)

(72) Inventors: Shriphani Palakodety, Palo Alto, CA (US); Volkmar Frinken, Santa Clara, CA (US); Guha Jayachandran, Cupertino, CA (US); Veni Singh, San Mateo, CA (US)

(21) Appl. No.: 15/863,946

(22) Filed: Jan. 7, 2018

Related U.S. Application Data
(60) Provisional application No. 62/444,084, filed on Jan. 9, 2017.

(51) Int. Cl. G10L 17/22; G10L 17/04; G10L 17/00; G10L 17/18; G10L 17/02; G10L 17/06

(52) U.S. Cl. CPC G10L 17/22; G10L 17/04; G10L 17/06; G10L 17/18; G10L 17/02; G10L 17/005

(57) ABSTRACT

A client device retrieves a diarization model. The diarization model has been trained to determine whether there is a change of one speaker to another speaker within an audio sequence. The client device receives enrollment data from each speaker of a group of speakers who are participating in an audio conference. The client device obtains an audio segment from a recording of the audio conference. The client device identifies one or more speakers for the audio segment by applying the diarization model to a combination of the enrollment data and the audio segment.

### CROSS-REFERENCE TO RELATED APPLICATION(S)

This application claims priority under 35 U.S.C. § 119(e) to U.S. Provisional Patent Application Ser. No. 62/444,084, titled “A System and Method for Diarization of Speech, Automated Generation of Transcripts, and Automatic Information Extraction,” filed Jan. 9, 2017, the disclosure of which is hereby incorporated by reference herein in its entirety.

### TECHNICAL FIELD

The present disclosure relates to speech recognition, in particular, to automated labeling of speakers who spoke in an audio of speech, also referred to as diarization; automated generation of a text transcript from an audio with one or more speakers; and automatic information extraction from an audio with one or more speakers.

### BACKGROUND

Automated speech-to-text methods have advanced in capability in recent years, as seen in applications used on smartphones. However, these methods do not distinguish between different speakers to generate a transcript of, for example, a conversation with multiple participants. Speaker identity needs to be either manually added, or inferred based on transmission source in the case of a recording of a remote conversation. Furthermore, data contained within the text must be manually parsed, requiring data entry personnel to manually re-input information of which there is already a digital record.

Old techniques such as Independent Component Analysis (ICA) require multiple recording devices (such as microphones) to record audio. Multiple devices are positioned in different places, and thus can catch and record different signals of the same conversation so that they supplement one another. Further, although these techniques have been approved in theory, they have not worked in practice. New methods working with only one recording device are therefore desired, as opposed to ICA and other such techniques that even in theory require multiple recording devices.

The problem of diarization has been actively studied in the past. It is applicable in settings as diverse as biometric identification and conversation transcript generation. Typical approaches to diarization involve two major steps: a training phase where sufficient statistics are extracted for each speaker and a test phase where a goodness of fit test is applied that provides a likelihood value that an utterance is attributable to a particular speaker.

Two popular approaches are the i-vector method and the Joint Factor Analysis (JFA) method. Both approaches first construct a model of human speech using a corpus of a large number (typically hundreds) of speakers. The model is typically a mixture of Gaussians on some feature descriptors of audio segments, such as short-term Fourier transform (STFT) or mel-frequency cepstral coefficients (MFCC). It is called the universal background model (UBM).

Each of the speakers for whom enrollment data is available is modeled as deviations from the UBM. Enrollment data refers to a sample of speech from which statistics for that speaker's voice can be extracted. The JFA method describes a particular speaker's model as a combination of (i) the UBM, (ii) a speaker-specific component, (iii) a channel-dependent component (unique to the equipment), and (iv) a residual speaker-specific component. The i-vector method constructs a speaker model as a combination of the UBM and an i-vector specific to each speaker.

However, the i-vector and JFA methods, along with all other methods, are of limited accuracy, require construction of a UBM and rely on longer than ideal enrollment data. Many applications, including automated generation of transcripts from medical appointments or business meetings, would benefit from an alternative method. Furthermore, an alternative method for diarization would be useful to automatically generate a text transcript corresponding to an audio conversation, while the generated text transcript is useful in its own right as well as to enable information extraction.

### SUMMARY

A computer-implemented method is disclosed for identifying a speaker for audio data. Embodiments of the method comprise generating a diarization model based on an amount of audio data by multiple speakers. The diarization model is trained to determine whether there is a change of one speaker to another speaker within an audio sequence. The embodiments of the method further comprise receiving enrollment data from each one of a group of speakers who are participating in an audio conference, and obtaining an audio segment from a recording of the audio conference. One or more speakers are identified for the audio segment by applying the diarization model to a combination of the enrollment data and the audio segment.

Another aspect of the disclosure is a non-transitory computer-readable storage medium storing executable computer program instructions for updating content on a client device. The computer program instructions comprise instructions for generating a diarization model based on an amount of audio data by multiple speakers. The diarization model is trained to determine whether there is a change of one speaker to another speaker within an audio sequence. The computer program instructions also comprise instructions for receiving enrollment data from each one of a group of speakers who are participating in an audio conference, obtaining an audio segment from a recording of the audio conference and identifying one or more speakers for the audio segment by applying the diarization model to a combination of the enrollment data and the audio segment.

Still another aspect of the disclosure provides a client device for identifying a speaker for audio data. One embodiment of the client device comprises a computer processor for executing computer program instructions and a non-transitory computer-readable storage medium storing computer program instructions. The computer program instructions are executable to perform steps comprising retrieving a diarization model. The diarization model has been trained to determine whether there is a change of one speaker to another speaker within an audio sequence. The computer program instructions are executable to also perform steps of receiving enrollment data from each speaker of a group of speakers who are participating in an audio conference, obtaining an audio segment from a recording of the audio conference and identifying one or more speakers for the audio segment by applying the diarization model to a combination of the enrollment data and the audio segment.

One of the advantages is that the disclosure does not require ahead-of-time knowledge about speakers' voices in order to identify speakers for segments of audio data and generate transcripts of the audio data sorted by identified speakers. Another advantage is that the disclosure diarizes speech rapidly and accurately while requiring only minimal enrollment data for each speaker. Moreover, the disclosed embodiments can work with only one device (such as microphone) for recording the audio, rather than requiring multiple recording devices (such as microphones) to record audio.

Beneficially, but without limitation, the disclosure enables deploying the system or method in a doctor's office to automatically generate a transcript of a patient encounter and to, based on information verbally supplied in the encounter, automatically populate fields in an electronic medical record, and allow after-the-fact querying with answers automatically provided.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level block diagram of a computing environment for supporting diarization, transcript generation and information extraction according to one embodiment.

FIG. 2 is a high-level block diagram illustrating an example of a computer for acting as a client device and/or media server in one embodiment.

FIG. 3 is a high-level block diagram illustrating a diarization module according to one embodiment.

FIG. 4 is a high-level block diagram illustrating a determination module of the diarization module according to one embodiment.

FIG. 5 is a flowchart illustrating a process for identifying speakers for audio data implemented by the diarization module according to one embodiment.

FIG. 6 is a flowchart illustrating a process for determining a speaker for an audio segment implemented by the determination module according to one embodiment.

FIG. 7 is a diagram illustrating a process for identifying speakers for audio data.

FIG. 8 is a diagram illustrating another process for identifying speakers for audio data.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### System Overview

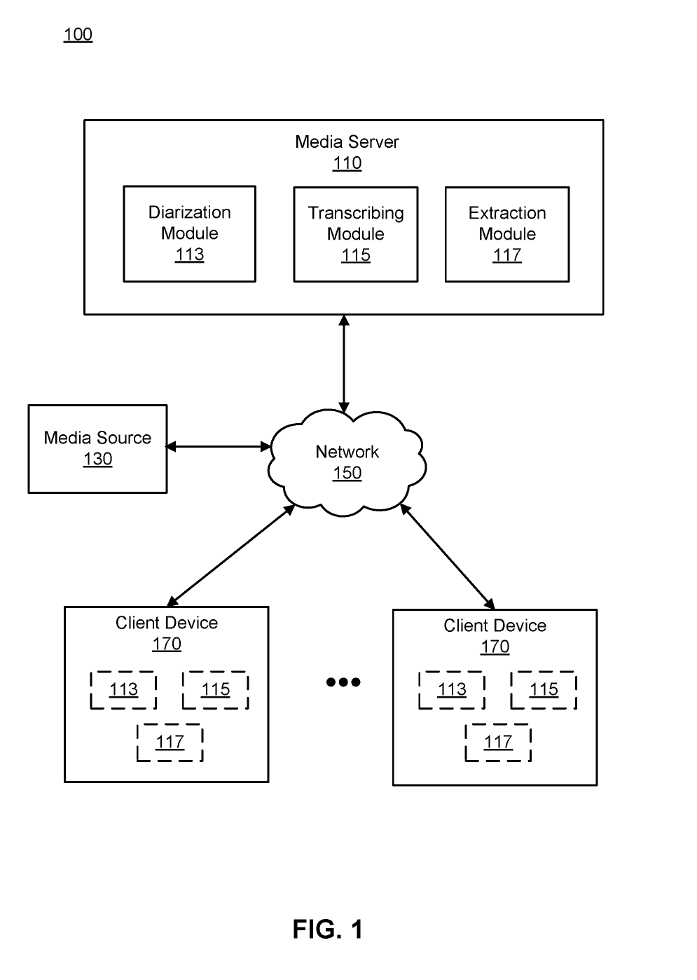

FIG. 1 shows a computing environment 100 for supporting diarization of audio data, text transcript generation and information extraction according to one embodiment. The computing environment 100 includes a media server 110, a media source 130 and a plurality of client devices 170 connected by a network 150. Only one media server 110, one media source 130 and two client devices 170 are shown in FIG. 1 in order to simplify and clarify the description. Embodiments of the computing environment 100 can have many media servers 110, media sources 130 and client devices 170 connected to the network 150. Likewise, the functions performed by the various entities of FIG. 1 may differ in different embodiments.

The media source 130 functions as the originator of the digital audio or video data. For example, the media source 130 includes one or more servers connected to the network 150 for providing a variety of different types of audio or video data. Audio data may include digital recordings of speech or songs, and live data stream of speech or songs. Video data may include digital recordings of movies, or other types of videos uploaded by users. In other examples, audio data may be recordings or live stream of conference or conversations.

In one embodiment, the media source 130 provides audio or video data to the media server 110, and the media server provides audio or video data annotated with identities of speakers, text transcripts associated with audio or video data, or extracted information from the audio or video data to the client devices 170. In other embodiments, the media source 130 provides audio data to the media server 110 for generating and training a neural network diarization model based on a large amount of the audio data. The diarization model can be used by the media server 110 or the client devices 170 to identify speakers or singers for future video or audio data.

In one embodiment, the media server 110 provides for diarization, either for live or pre-recorded audio data or files; transcribing the audio data or files in which different speakers are recognized and appended to the audio data or files; extracting information from the transcribed audio data or files for automatic database population or automated question answering; and sending the results to the client devices 170 via the network 150. In another embodiment, the media server 110 provides for diarization for pre-recorded video data or files; transcribing the video data or files in which different speakers are recognized and appended to the video data or files; extracting information from the transcribed video data or files for automatic database population or automated question answering; and sending the results to the client devices 170 via the network 150. Examples of pre-recorded videos include, but are not limited to, movies, or other types of videos uploaded by users to the media server 110.

In one embodiment, the media server 110 stores digital audio content collected from the media source 130. In another embodiment, the media server 110 serves as an interface between the client devices 170 and the media source 130 but does not store the audio data. In one embodiment, the media server 110 may be a part of cloud computation or cloud storage system.

The media server 110 includes a diarization module 113, a transcribing module 115 and an extraction module 117. Other embodiments of the media server 110 include different and/or additional modules. In addition, the functions may be distributed among the modules in a different manner than described herein.

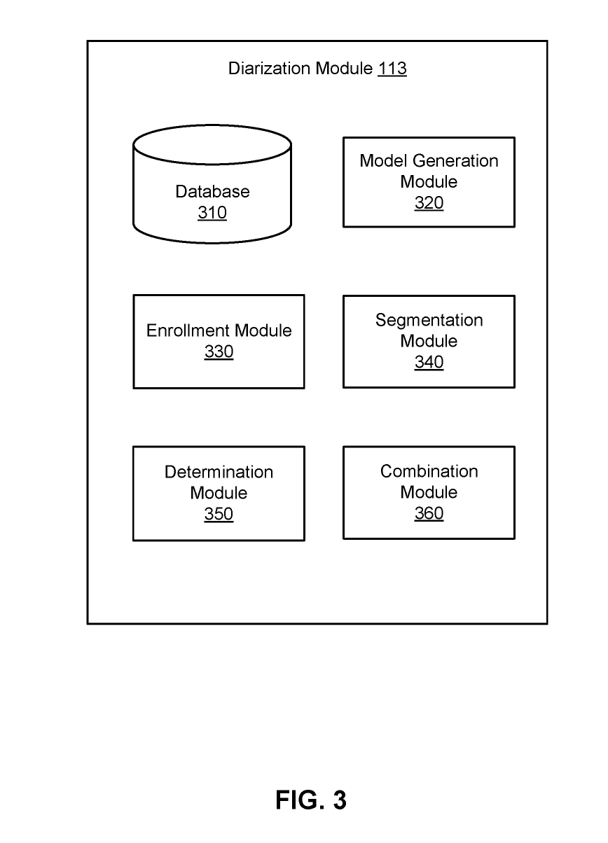

The diarization module 113 utilizes a deep neural network to determine if there has been a speaker change in the midst of an audio or video sample. Beneficially, the diarization module 113 may determine one or more speakers for pre-recorded or live audio without prior knowledge of the one or more speakers. The diarization module 113 may determine speakers for pre-recorded videos without prior knowledge of the speakers in other examples. The diarization module 113 may extract audio data from the pre-recorded videos and then apply the deep neural network to the audio data to identify speakers. In one embodiment, the diarization module 113 diarizes speakers for audio data and passes each continuous segment of audio belonging to an individual speaker to the transcribing module 115. In other embodiments, the diarization module 113 receives text transcripts of audio from the transcribing module 115 and uses the text transcripts as extra input for diarization. An exemplary diarization module 113 is described in more detail below with reference to FIG. 3.

The transcribing module 115 uses a speech-to-text algorithm to transcribe audio data into text transcripts. For example, the transcribing module 115 receives all continuous audio segments belonging to a single speaker in a conversation and produces a text transcript for the conversation where each segment of speech is labeled with a speaker. In other examples, the transcribing module 115 executes the speech-to-text method on the recorded audio data and sends the text transcript to the diarization module 113 as an extra input for diarization. Following diarization, the transcribing module 115 may break up the text transcript by speaker.

The extraction module 117 uses a deep neural network to extract information from transcripts and to answer questions based on content of the transcripts. In one embodiment, the extraction module 117 receives text transcripts generated by the transcribing module 115 and extracts useful information from the text transcripts. For example, the extraction module 117 extracts information such as patient's profile information and health history from text transcripts to answer related questions. In other embodiments, the extraction module 117 extracts information from transcripts obtained from other sources. The transcripts may be generated by methods other than the ones used by the modules or systems described in these disclosed embodiments. The extracted information may either be used for populating fields in a database or for question-answering.

In one embodiment, the extraction module 117 uses two approaches: (i) slot-filling which populates known categories (such as columns in a database) with relevant values; and (ii) entity-linking, which discovers relationships between entities in the text and constructs knowledge graphs.

In one embodiment, for set fields in a database (such as vital signs or chief complaint summary in an electronic medical record), the extraction module 117 processes the obtained transcript and fills in the appropriate values for the schema with slot-filling. In other embodiments, the extraction module 117 typically combines a high-precision technique that matches sentences to pre-constructed text patterns and a high-recall technique such as distant supervision where all entity-pairs from existing relations in a knowledge base are identified in the given corpus and a model is built to retrieve those exact relations from the corpus. In yet other embodiments, the extraction module 117 utilizes competitive slot-filling techniques such as the techniques used by the DeepDive system, where the extraction module 117 uses a combination of manual annotation and automatically learned features for extracting relations. In one embodiment, the extraction module 117 uses the same primitives to extract entities and elucidate relationships based on the entity-linking and slot-filling techniques.

In one embodiment, the extraction module 117 discovers entities and relationships between them by deploying entity linking. For example, the extraction module 117 may exploit several natural-language processing tools such as named-entity-recognition (NER) and relation-extraction. More advantageously, the extraction module 117 applies question answering deep neural networks to transcripts. For example, in the question answering setting, the extraction module 117 utilizes a model to answer questions after processing a body of text transcript. In a medical setting, for example, questions to be answered may include, “How did the patient get injured?” “When did the double vision begin?” etc.

A client device 170 is an electronic device used by one or more users to perform functions such as consuming digital content, executing software applications, browsing websites hosted by web servers on the network 150, downloading files, and interacting with the media server 110. For example, the client device 170 may be a dedicated e-Reader, a smart phone, or a tablet, notebook, or desktop computer. In other examples, the client devices 170 may be any specialized devices. The client device 170 includes and/or interfaces with a display device that presents the content to the user. In addition, the client device 170 provides a user interface (UI), such as physical and/or on-screen buttons, with which the user may interact with the client device 170 to perform functions such as consuming, selecting, and purchasing content. For example, the client device 170 may be a device used in doctor's office for record patient's health information or history.

In one embodiment, the client device 170 includes one or more of the diarization module 113, the transcribing module 115 and the extraction module 117 as one or more local applications, instead of having the media server 110 to include these modules 113, 115, 117 to implement the functionalities. For example, one or more of these modules 113, 115, 117 may reside on the client device 170 to diarize or transcribe a conversation, or provide function of information extraction. For example, the diarization module 113 and the transcribing module 115 may be included on the client device 170 to differentiate between different speakers, and annotate the transcript accordingly. Relevant data can be parsed from the conversation and automatically added to a database.

A user of the client device 170 may access the annotated transcript through the interface of the client device 170 locally. A user of the client device 170 may enter questions through the interface. The extraction module 117 may extract information from the annotated transcript to answer the questions entered by the user. Other embodiments of the client device 170 include, but are not limited to, a dedicated device 170 for securely recording and parsing medical patient-doctor conversations, lawyer-client conversations, or other highly sensitive conversations.

In one embodiment, the client device 170 may send the annotated transcript to the media server 110 or other third party servers. A user can either access the transcript through going onto a website, or typing in questions that can be answered by the extraction module 117 on the media server 110 or the other third party servers. Other embodiments of the client device 170 include different and/or additional modules. In addition, the functions may be distributed among the modules in a different manner than described herein.

The network 150 enables communications among the media source 130, the media server 110, and client devices 170 and can comprise the Internet. In one embodiment, the network 150 uses standard communications technologies and/or protocols. In another embodiment, the entities can use custom and/or dedicated data communications technologies.

### Computing System Architecture

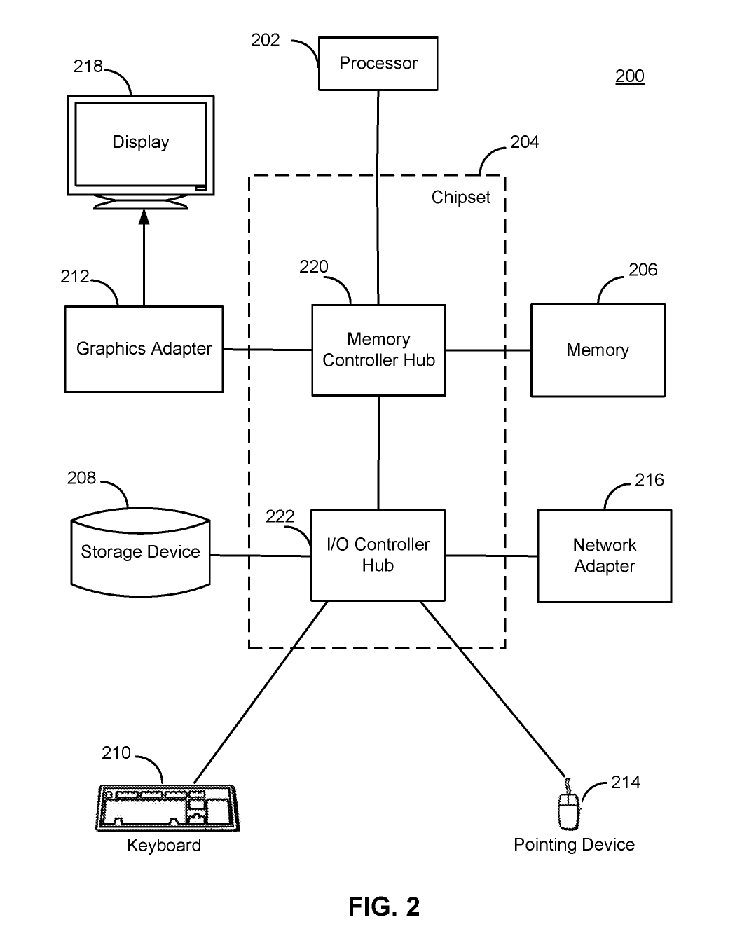

The entities shown in FIG. 1 are implemented using one or more computers. FIG. 2 is a high-level block diagram of a computer 200 for acting as the media server 110, the media source 130 and/or a client device 170. Illustrated are at least one processor 202 coupled to a chipset 204. Also coupled to the chipset 204 are a memory 206, a storage device 208, a keyboard 210, a graphics adapter 212, a pointing device 214, and a network adapter 216. A display 218 is coupled to the graphics adapter 212. In one embodiment, the functionality of the chipset 204 is provided by a memory controller hub 220 and an I/O controller hub 222. In another embodiment, the memory 206 is coupled directly to the processor 202 instead of the chipset 204.

The storage device 208 is any non-transitory computer-readable storage medium, such as a hard drive, compact disk read-only memory (CD-ROM), DVD, or a solid-state memory device. The memory 206 holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 150.

As is known in the art, a computer 200 can have different and/or other components than those shown in FIG. 2. In addition, the computer 200 can lack certain illustrated components. For example, the computers acting as the media server 110 can be formed of multiple blade servers linked together into one or more distributed systems and lack components such as keyboards and displays. Moreover, the storage device 208 can be local and/or remote from the computer 200 (such as embodied within a storage area network (SAN)).

As is known in the art, the computer 200 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 208, loaded into the memory 206, and executed by the processor 202.

### Diarization

FIG. 3 is a high-level block diagram illustrating the diarization module 113 according to one embodiment. In the embodiment shown, the diarization module 113 has a database 310, a model generation module 320, an enrollment module 330, a segmentation module 340, a determination module 350, and a combination module 360. Those of skill in the art will recognize that other embodiments of the diarization module 113 can have different and/or additional modules other than the ones described here, and that the functions may be distributed among the modules in a different manner.

In some embodiments, the modules of the diarization module 113 may distributed among the media server 110 and the client device 170. For example, the model generation module 320 may be included on the media server 110, while the other modules 330, 340, 350, 360 may be included on the client device 170. In other examples, while the enrollment module 330 may be included on the client device 170, other modules 320, 340, 350, 360 may be included on the media server 110.

The database 310 stores video data or files, audio data or files, text transcript files and information extracted from the transcript. In some embodiments, the database 310 also stores other data used by the modules within the diarization module 113 to implement the functionalities described herein.

The model generation module 320 generates and trains a neural network model for diarization. In one embodiment, the model generation module 320 receives training data for the diarization model. The training data may include, but are not limited to, audio data or files, labeled audio data or files, and frequency representations of sound signals obtained via Fourier Transform of audio data (e.g., via short-form Fourier Transform). For example, the model generation module 320 collects audio data or files from the media source 130 or from the database 310. The audio data may include recorded audio speeches by a large number of speakers (such as hundreds of speakers) or recorded audio songs by singers. In other examples, the audio data may be extracted from pre-recorded video files such as movies or other types of videos uploaded by users.

In one embodiment, the training data may be labeled. For example, an audio sequence may be classified into two categories of one and zero (which is often called as binary classification). An audio sequence by the same speaker may be labeled as one, while an audio sequence consisting of two or more different speakers' speech segments may be labeled as zero, or vice versa. The binary classification can also be applied to other types of audio data such as records of songs by the same singer or by two or more different singers.

In one embodiment, the model generation module 320 generates and trains the diarization model based on the training data. For example, the diarization model may be a long short-term memory (LSTM) deep neural network. The model generation module 320 trains the diarization model by using the training data as input to the model, using results of the binary classification (such as one or zero) as the output of the model, calculating a reward, and maximizing the reward by adjusting parameters of the model. The training process may be implemented recursively until the reward converges. The trained diarization model may be used to produce a similarity score for a future input audio sequence. The similarity score describes a likelihood whether there is a change of one speaker or singer to another speaker or singer within the audio sequence or the audio sequence is spoken by the same speaker or sung by the same singer for all segments within it. In one embodiment, the similarity score may be interpreted as a distance metric.

In one embodiment, the model generation module 320 tests the trained diarization model for determining whether an audio sequence is spoken by one speaker or singer (or voice), e.g., no change from one speaker to another, or the audio sequence consists of two or more audio segments of different speakers or singers (or voices). For example, the model generation module 320 may test the model using random audio data other than training data, e.g., live audio or video conference or conversation, recorded audio or video data by one or more speakers or singers. After the diarization model is trained and tested, the model generation module 320 may send the trained model to the other modules of the diarization module 113, such as the determination module 350. The model generation module 320 may send the trained model to the database 310 for later use by other modules of the diarization module 113.

The enrollment module 330 receives enrollment data. In one embodiment, the enrollment module 330 may cooperate with other modules or applications on the media server 110 or on the client device 170 to receive enrollment data. For example, the enrollment data may include an audio sample (such as a speech sample) from a speaker. In another example, the enrollment data may be a singing sample from a singer in a scenario where a singer is joining an online event. Advantageously, by using the methods described hereinafter, the enrollment data may be short or minimal. For example, the enrollment audio sample may be between sub-second and 30 seconds in length.

In one embodiment, if enrollment data is not already available for one or more of the participants in an audio conference or conversation desired to be diarized, then the enrollment module 330 may request each of the new enrollees to provide enrollment data. For example, when a new enrollee opens an audio or video conference interface indicating that the enrollee is about to join the conference, the enrollment module 330 cooperates with the conference application (either residing on the media server 110 or on the client device 170) to send a request to the enrollee through the interface of the conference application to request the enrollee to provide the enrollment data by reading a given sample of text or by speaking randomly. Alternatively, the enrollment module 330 may automatically construct the enrollment data for each participant over the course of the conversation. In one embodiment, when a pre-recorded video is desired to be diarized, the enrollment module 330 may construct the enrollment data for each actor or actress over the course of the video.

The segmentation module 340 receives audio sequence from other modules or applications on the media server 110 or on the client device 170, and divides the audio sequence into short segments. For example, while a conversation is going on, the segmentation module 340 cooperates with the application presenting or recording the conversation to receive an audio recording of the conversation. In another example, the segmentation module 340 receives an audio recording of a pre-recorded video file.

The segmentation module 340 divides the audio recording into short audio segments. For example, an audio segment may be of a length between tens and hundreds of milliseconds, depending on the desired temporal resolution. In one embodiment, the segmentation module 340 extracts one or more audio segments and sends to the determination module 350 to determine a speaker for each audio segment. In other embodiments, the segmentation module 340 stores the audio segments into the database 310 for use of the determination module 350 or other modules or applications on the media server 110 or on the client device 170.

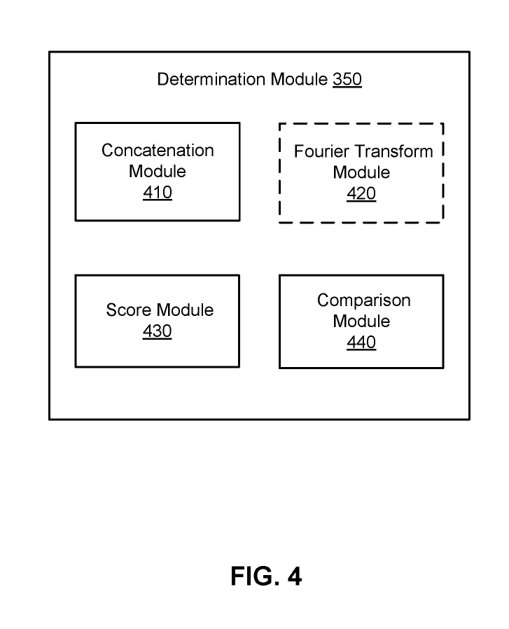

The determination module 350 receives an audio segment from the segmentation module 340 and identifies one or more speakers for the audio segment among all participants to the audio conference or conversation. In one embodiment, the determination module 350 applies the trained diarization model to a combination of the audio segment and enrollment data from each speaker of the audio conference or conversation to determine which speaker uttered the audio segment. The combination of the audio segment and the enrollment data may be a concatenation of an enrollment sample from a speaker and the audio segment. Other examples of the combination of the audio segment and the enrollment data are possible. The determination module 350 will be described in further detail below with reference to FIG. 4.

The combination module 360 combines continuous audio segments with the same identified speaker. For example, once the speaker for every audio segment has been determined by the determination module 350, the combination module 360 combines continuous audio segments of the same speaker. This way, the original input audio sequence may be organized into blocks for each of which the speaker has been identified. For example, the combination module 360 detects continuous short audio segments of the same identified speaker and combines them into a longer audio block. By going through all the short audio segments and combining continuous segments with the same identified speaker, the combination module 360 sorts the original input audio recording into audio blocks each of which is associated with one identified speaker. In one embodiment, the combination module 360 sends the audio recording segmented by speaker to the transcribing module 115 for transcribing the audio recording. In other embodiments, the combination module 360 stores the speaker-based segmented audio recording in the database 310 for use of the transcribing module 115 or other modules or applications on the media server 110 or on the client device 170.

### Determination Module

FIG. 4 is a high-level block diagram illustrating the determination module 350 in the diarization module 113 according to one embodiment. In the embodiment shown, the determination module 350 includes a concatenation module 410, a score module 430, and a comparison module 440, and optionally includes a Fourier Transform module 420. Other embodiments of determination module 350 include different and/or additional modules. In addition, the functions may be distributed among the modules in a different manner than described herein.

The concatenation module 410 receives an enrollment sample from a speaker from the enrollment module 330, and an audio segment from the segmentation module 340. The concatenation module 410 concatenates the enrollment sample and the audio segment. For example, the concatenation module 410 appends the audio segment to the enrollment sample of the speaker, and forms a concatenated audio sequence that consists of two consecutive sections—the enrollment sample of the speaker and the audio segment. In one embodiment, the concatenation module 410 concatenates the audio segment and an enrollment sample of each participant in an audio conference or conversation. For example, the concatenation module 410 appends the audio segment to an enrollment sample from each speaker in an audio conference, and forms concatenated audio sequences each of which consists of the enrollment sample from a different speaker participating in the audio conference and the audio segment.

Optionally, the determination module 350 includes the Fourier Transform module 420 for processing the audio sequence by Fourier Transform before feeding the sequence to the neural network model generated and trained by the model generation module 320. In one embodiment, if the model generation module 320 has generated and trained a neural network model for identifying a speaker or singer for audio data by using frequency representations obtained from Fourier Transform of the audio data as input of the model, then the Fourier Transform module 420 processes the audio sequence received from the concatenation module 410 by Fourier Transform to obtain frequencies of the audio sequence, and sends the frequencies of the audio sequence to the score module 430 to determine the speaker or singer for the audio sequence. For example, Fourier Transform module 420 may apply the short-term Fourier Transform (STFT) to audio sequence.

The score module 430 computes a similarity score for an input audio sequence based on the diarization model generated and trained by the model generation module 320. In one embodiment, the similarity score describes the likelihood that the speaker of the enrollment sample and the speaker of the audio segment are the same. In another embodiment, the similarity score may describe the likelihood that the speaker of the enrollment sample and the speaker of the audio segment are different. In yet other embodiments, the similarity score may describe the likelihood whether the singers of the enrollment sample and the audio segment are the same or not.

As described above with reference to the model generation module 320 in FIG. 3, the model generation module 320 trains the deep neural network diarization model to determine the likelihood that a given audio sample of speech contains any speaker or singer change within it. The score module 430 receives the concatenated audio sequence and uses the diarization model to determine the likelihood that there is a speaker change between the enrollment sample and the audio segment. If the score module 430 determines the likelihood is low, for example, lower than 50%, 40%, 30%, 20%, 10%, 5%, 1%, or other reasonable percentages, then the audio segment that was concatenated to the enrollment sample to form the audio sequence may have been spoken by the same speaker of the enrollment sample. Alternatively, the similarity score may indicate a likelihood that there is no speaker change between the enrollment sample and the audio segment. Accordingly, if the similarity score is high, for example, higher than 99%, 95%, 90%, 80%, 70%, 60%, or other reasonable percentages, then the audio segment may have been spoken by the same speaker of the enrollment sample.

In one embodiment, the score module 430 determines the similarity score for each concatenated audio sequence generated by each speaker's enrollment sample and the audio segment. In one embodiment, the score module 430 sends the similarity score for each concatenated audio sequence to the comparison module 440 for comparing the similarity scores to identify the speaker for the audio segment.

The comparison module 440 compares the similarity scores for the concatenated audio sequences based on each speaker's enrollment sample, and identifies the audio sequence with the highest score. By determining a concatenated audio sequence with the highest score, the comparison module 440 determines the speaker of the audio segment is the speaker of the enrollment sample constructing the concatenated audio sequence with the highest score. The comparison module 440 returns the speaker as the identified speaker of the audio segment.

In one embodiment, the comparison module 440 tests the highest score against a base threshold. For example, the threshold may be of a reasonable value or percentage. If the highest score is lower than the base threshold, then the comparison module 440 may return an invalid result indicating the speaker of the audio segment is uncertain or unable to be determined. In other embodiments, the comparison module 440 skips the step of comparing the highest score with a base threshold and output the speaker corresponding to the highest score as the speaker of the audio segment.

In one embodiment, when two or more highest similarity scores are close, the comparison module 440 may return all the speakers corresponding to the two or more highest similarity scores. For example, if the difference between two highest similarity scores is within a certain range, e.g., within 1%, 5%, 10%, or other reasonable percentages, then the comparison module 440 returns the two speakers corresponding to the two highest scores as identified speakers.

### Exemplary Processes

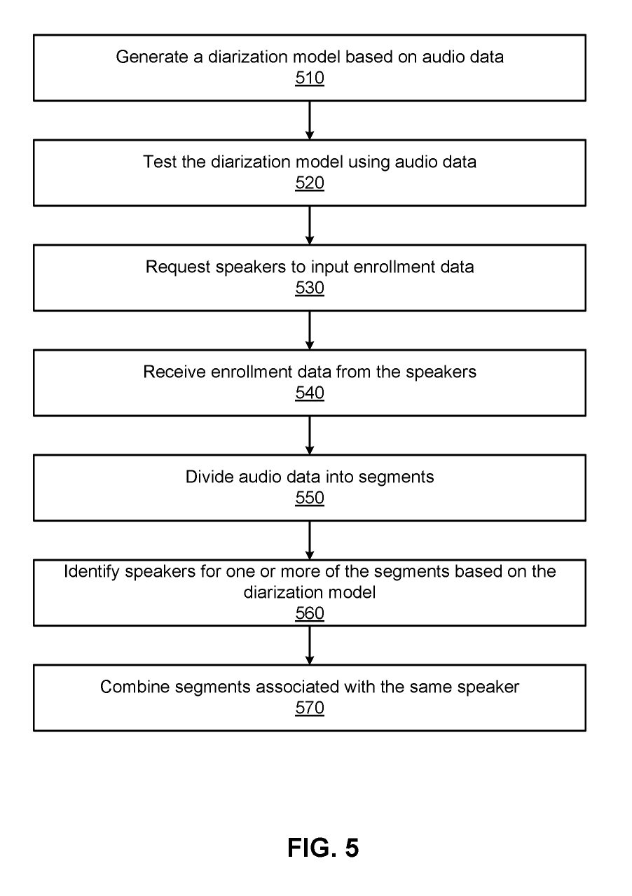

FIG. 5 is a flowchart illustrating a process for identifying speakers for audio data according to one embodiment. FIG. 5 attributes the steps of the process to the diarization module 113. However, some or all of the steps may be performed by other entities. In addition, some embodiments may perform the steps in parallel, perform the steps in different orders, or perform different steps.

Initially, the diarization module 113 generates 510 a diarization model based on audio data. As described previously with regard to FIG. 3, the diarization module 113 may generate and train a diarization model, such as a deep neural network, based on collected audio data, such as audio speeches by aggregate hundreds of speakers. The audio data may be processed by Fourier Transform to generate frequencies of the audio data as training data for training the diarization model. The audio data may be labeled before being input to the diarization model for training.

The diarization module 113 tests 520 the diarization model using audio data. The diarization module 113 inputs audio sequence of either the same speaker or different speakers to the diarization model to obtain a similarity score. The similarity score indicates the likelihood that there is a speaker change within the audio sequence. The diarization module 113 evaluates the diarization model by determining if the likelihood computed by the model correctly indicates the speaker change, and correctly indicates there is no such change. Based on the evaluation, the diarization module 113 may do more training of the model if the model cannot determine speakers correctly, or send the model for use if the model can determine speakers correctly.

The diarization module 113 requests 530 speakers to input enrollment data. In one embodiment, the diarization module 113 cooperates with other modules or applications of the media server 110 or the client device 170 to request participants of a conference to provide enrollment data. The diarization module 113 receives 540 enrollment data from the speakers. For example, the enrollment data may be a speech sample of a speaker. The enrollment data may be received by allowing the speaker to randomly speak some sentences or words, or by requesting the speaker to read certain pre-determined sentences.

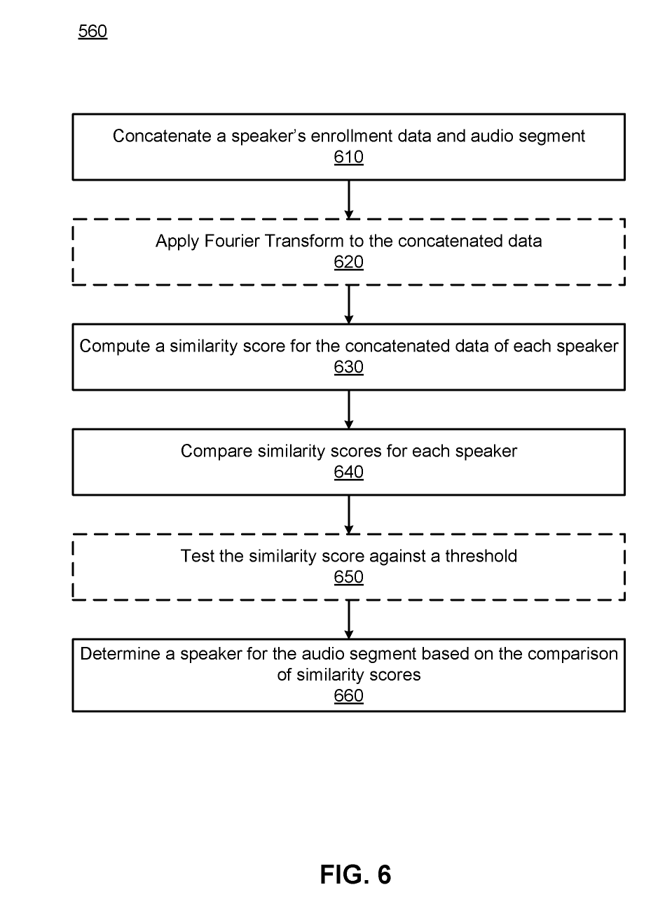

The diarization module 113 divides 550 audio data into segments. For example, the participants speak during a conference and the diarization module 113 receives the audio recording of the conference and divides the audio recording into short audio segments. An audio segment may be ten to hundreds of milliseconds in length. The diarization module 113 identifies 560 speakers for one or more of the segments based on the diarization model. This step will be described in more detail below with reference to FIG. 6.

The diarization module 113 combines 570 segments associated with the same speaker. In one embodiment, the diarization module 113 combines continuous audio segments by the same speaker identified in the last step 560 to generate audio blocks. As a result, the diarization module 113 segments the original input audio sequence into audio blocks and each of the audio blocks is spoken by one speaker.

FIG. 6 is a flowchart illustrating a process for determining a speaker for an audio segment according to one embodiment. FIG. 6 attributes the steps of the process to the determination module 350 of the diarization module 113. However, some or all of the steps may be performed by other entities. In addition, some embodiments may perform the steps in parallel, perform the steps in different orders, or perform different steps.

Initially, the determination module 350 concatenates 610 a speaker's enrollment data and an audio segment. For example, the determination module 350 receives a speaker's enrollment sample from the enrollment module 330 and an audio segment from the segmentation module 340. The determination module 350 appends the audio segment to the speaker's enrollment sample.

Optionally, the determination module 350 applies 620 Fourier Transform to the concatenated data. For example, the determination module 350 may process the audio sequence generated by concatenating the enrollment sample and the audio segment by a short-form Fourier Transform. The determination module 350 computes 630 a similarity score for the concatenated data of each speaker. For example, the determination module 350 uses the diarization model to compute the similarity score for each concatenated audio sequence consisting of a different speaker's enrollment sample followed by the audio segment.

At step 640, the determination module 350 compares 640 similarity scores for each speaker. For example, the determination module 350 determines the audio sequence with the highest score by the comparison, and the speaker of the enrollment sample constructing that audio sequence with the highest score has the highest chance to be the speaker of the audio segment.

Optionally, the determination module 350 tests 650 the highest similarity score against a threshold. If the highest similarity score is lower than the threshold, then the determination module 350 returns an invalid result indicating the speaker of the audio segment is unable to be determined.

The determination module 350 determines 660 a speaker for the audio segment based on the comparison of the similarity scores. For example, the determination module 350 determines the speaker of the audio segment as the speaker whose enrollment sample constructs the audio sequence with the highest score.

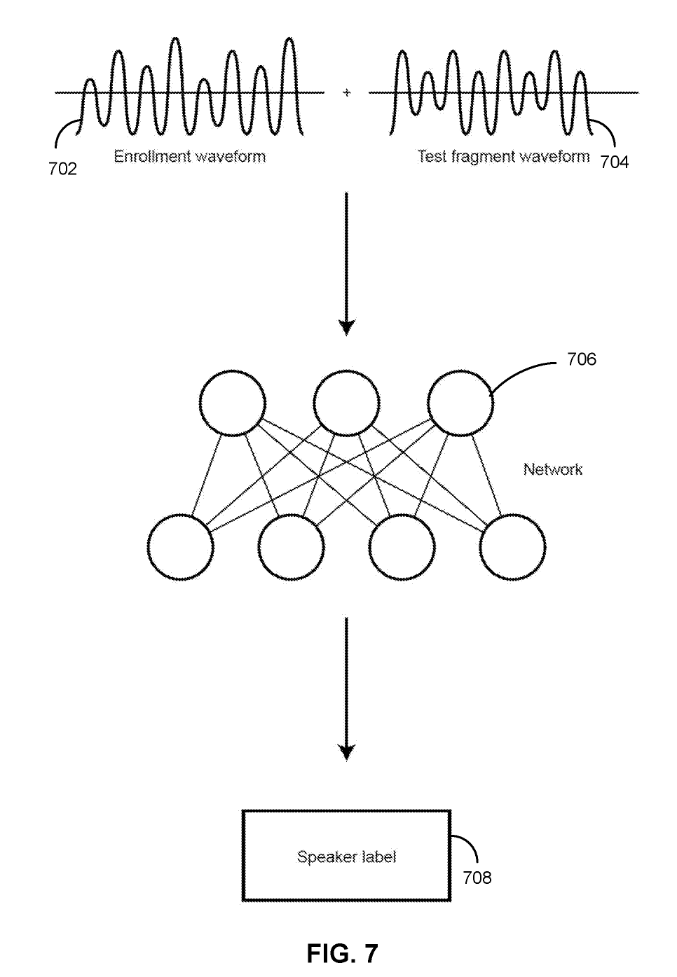

FIG. 7 is a diagram illustrating a process for identifying speakers for audio data. In the illustrated process, the waveform 702 represents an enrollment audio sample received from one speaker participating an audio or video conference. The waveform 704 represents a test fragment of audio signal obtained from either a live or pre-recorded audio or video file. The enrollment sample waveform 702 and the test fragment audio waveform 704 may be concatenated to form one concatenated audio sequence, as described above with reference to FIG. 3. The network 706 represents a deep neural network diarization model that receives the concatenated audio sequence as input. As a result of applying the network 706 to the concatenated audio sequence, the speaker of the test fragment of audio signal 704 can be determined.

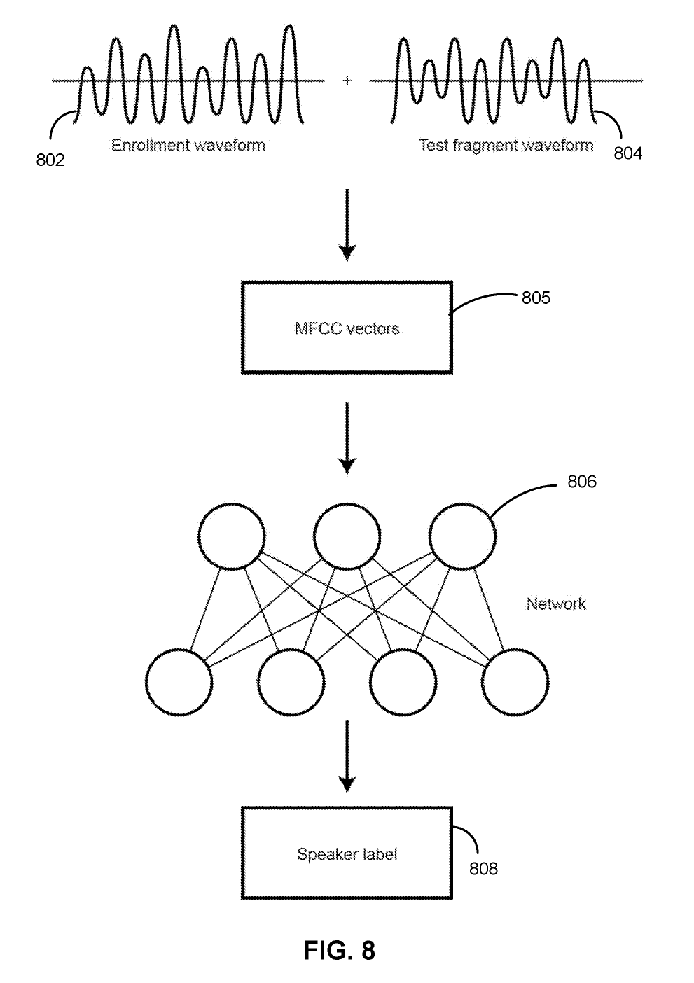

FIG. 8 is a diagram illustrating another process for identifying speakers for audio data. Similarly, the waveform 802 and waveform 804 represent an enrollment sample of a speaker and a test fragment of audio signal. The two waveform 802, 804 are concatenated to form a concatenated audio sequence. The block 805 represents a MFCC vectors. The concatenated audio sequence is transformed to frequency domain by MFCC 805, before being input to the deep neural network diarization model 806. After applying the diarization model 806 to the frequency representations of the concatenated audio sequence, the speaker of the test fragment of audio signal can be identified, as described in detail with reference to FIG. 3.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

The invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the invention include process steps and instructions described herein in the form of an algorithm. It should be noted that the process steps and instructions of the invention could be embodied in software, firmware or hardware, and when embodied in software, could be downloaded to reside on and be operated from different platforms used by real time network operating systems.

The invention also relates to an apparatus for performing the operations herein. This apparatus may be specially constructed for the required purposes, or it may comprise a general-purpose computer selectively activated or reconfigured by a computer program stored on a computer readable storage medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will be apparent to those of skill in the art, along with equivalent variations. In addition, the invention is not described with primary to any particular programming language. It is appreciated that a variety of programming languages may be used to implement the teachings of the invention as described herein, and any reference to specific languages are provided for disclosure of enablement and best mode of the invention.

The invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the invention is intended to be illustrative, but not limiting, of the scope of the invention, which is set forth in the following claims.

What is claimed is:

1. A computer-implemented method of identifying a speaker for audio data, the method comprising:
generating a diarization model based on an amount of audio data by multiple speakers, the diarization model trained to determine whether there is a change of one speaker to another speaker within an audio sequence;
receiving enrollment data from each one of a group of speakers who are participating in an audio conference;
obtaining an audio segment from a recording of the audio conference; and
identifying one or more speakers for the audio segment by applying the diarization model to a combination of the enrollment data and the audio segment.

2. The method of claim 1, wherein generating the diarization model based on the amount of audio data by multiple speakers comprising:
using the amount of audio data by multiple speakers to train the diarization model;
wherein the diarization model is a deep neural network model.

3. The method of claim 1, wherein the enrollment data includes a sample of speech by one of the group of speakers participating in the audio conference.

4. The method of claim 1, wherein obtaining the audio segment comprises:
dividing the recording of the audio conference into multiple audio segments; and
extracting one of the audio segments.

5. The method of claim 4, further comprising:
identifying one or more speakers for each of the multiple audio segments; and
combining continuous audio segments with the same identified speaker.

6. The method of claim 1, wherein identifying one or more speakers for the audio segment comprises:
concatenating enrollment data from one of the groups of the speakers and the audio segment to form a concatenated audio sequence; and
computing a similarity score for the concatenated audio sequence, the similarity score describing a likelihood that the speaker of the enrollment data and the speaker the audio segment are the same.

7. The method of claim 6, further comprising:
comparing similarity scores computed for concatenated audio sequences each formed by enrollment data from a different speaker of the groups of the speakers and the audio segment to determine the concatenated audio sequence with the highest similarity score; and
determining a speaker for the audio segment as the speaker of the enrollment data that forms the concatenated audio sequence with the highest similarity score.

8. A non-transitory computer-readable storage medium storing executable computer program instructions for identifying a speaker for audio data, the computer program instructions comprising instructions for:
generating a diarization model based on an amount of audio data by multiple speakers, the diarization model trained to determine whether there is a change of one speaker to another speaker within an audio sequence;
receiving enrollment data from each one of a group of speakers who are participating in an audio conference;
obtaining an audio segment from a recording of the audio conference; and
identifying one or more speakers for the audio segment by applying the diarization model to a combination of the enrollment data and the audio segment.

9. The computer-readable storage medium of claim 8, wherein generating the diarization model based on the amount of audio data by multiple speakers comprises:
using the amount of audio data by multiple speakers to train the diarization model;
wherein the diarization model is a deep neural network model.

10. The computer-readable storage medium of claim 8, wherein the enrollment data includes a sample of speech by one of the group of speakers participating in the audio conference.

11. The computer-readable storage medium of claim 8, wherein obtaining the audio segment comprises:
dividing the recording of the audio conference into multiple audio segments; and
extracting one of the audio segments.

12. The computer-readable storage medium of claim 11, wherein the computer program instructions for obtaining the audio segment comprise instructions for:
identifying one or more speakers for each of the multiple audio segments; and
combining continuous audio segments with the same identified speaker.

13. The computer-readable storage medium of claim 8, wherein identifying one or more speakers for the audio segment comprises:
concatenating enrollment data from one of the groups of the speakers and the audio segment to form a concatenated audio sequence; and
computing a similarity score for the concatenated audio sequence, the similarity score describing a likelihood that the speaker of the enrollment data and the speaker the audio segment are the same.

14. The computer-readable storage medium of claim 13, wherein the computer program instructions for identifying one or more speakers for the audio segment comprise instructions for:
comparing similarity scores computed for concatenated audio sequences each formed by enrollment data from a different speaker of the groups of the speakers and the audio segment to determine the concatenated audio sequence with the highest similarity score; and
determining a speaker for the audio segment as the speaker of the enrollment data that forms the concatenated audio sequence with the highest similarity score.

15. A client device for identifying a speaker for audio data, comprising:
a computer processor for executing computer program instructions; and
a non-transitory computer-readable storage medium storing computer program instructions executable to perform steps comprising:
retrieving a diarization model, the diarization model trained to determine whether there is a change of one speaker to another speaker within an audio sequence;
receiving enrollment data from each speaker of a group of speakers who are participating in an audio conference;
obtaining an audio segment from a recording of the audio conference; and
identifying one or more speakers for the audio segment by applying the diarization model to a combination of the enrollment data and the audio segment.

16. The client device of claim 15, wherein the enrollment data includes a sample of speech by one of the group of speakers participating in the audio conference.

17. The client device of claim 15, wherein obtaining the audio segment comprises:
dividing the recording of the audio conference into multiple audio segments; and
extracting one of the audio segments.

18. The client device of claim 17, wherein the computer program instructions executable to perform steps further comprising:
identifying one or more speakers for each of the multiple audio segments; and
combining continuous audio segments with the same identified speaker.

19. The client device of claim 15, wherein identifying one or more speakers for the audio segment comprises:
concatenating enrollment data from one of the groups of the speakers and the audio segment to form a concatenated audio sequence; and
computing a similarity score for the concatenated audio sequence, the similarity score describing a likelihood that the speaker of the enrollment data and the speaker the audio segment are the same.

20. The client device of claim 19, wherein the computer program instructions executable to perform steps further comprising:
comparing similarity scores computed for concatenated audio sequences each formed by enrollment data from a different speaker of the groups of the speakers and the audio segment to determine the concatenated audio sequence with the highest similarity score; and
determining a speaker for the audio segment as the speaker of the enrollment data that forms the concatenated audio sequence with the highest similarity score.
